(19) United States
(12) Patent Application Publication
(10) Pub. No.: US 2003/0005061 A1
(43) Pub. Date: Jan. 2, 2003

(54) E-mail distribution system

(75) Inventors: Yasuhiko Inagaki, Ichinomiya-shi (JP); Kenji Murakami, Nagoya-shi (JP)

Correspondence Address: Darby & Darby, 805 Third Avenue, New York, NY, 10022, US

(73) Assignee: FREAD CO., LTD.

(21) Appl. No.: 10/000,630

(22) Filed: Nov. 1, 2001

(30) Foreign Application Priority Data
Jun. 28, 2001 (JP) 2001-196067

(51) Int. Cl. G06F 15/16

(52) U.S. Cl. 709/206

(57) ABSTRACT

The E-mail distribution system which will be distributed to each addressee in a mail server after adding a transmitting person's job administrator to an addressee automatically if an E-mail is sent from the terminal of a computer network system built in the organization. This E-mail distribution system possesses the automatic reading means which comes to have an individual data control area, an organization data control area, and an addressee addition program in the mail server. In this individual data control area, personal information, such as its affiliation post, job class, and an e-mail address, is memorized. In this organization data control area, organization information, such as its post and job class, is memorized based on this personal information. If an E-mail is sent, this addressee addition program will specify a transmitting person's job administrator from an individual data control area and an organization data control area, and will appoint him to be a new addressee. And the e-mail address of this addressee is added to an E-mail. In this way, the E-mail which had the new addressee added is distributed by the E-mail transmission protocol towards each addressee.

### BACKGROUND OF THE INVENTION

1. Field of the Invention

The present invention relates to transmission and reception of the E-mail in a computer network. More particularly, the invention relates to the system which distributes an E-mail.

2. Description of the Prior Art

In the organization of a company etc., in order to perform information interchange in an organization etc. efficiently, the case where the computer network (LAN) which utilized the Internet technology, and the so-called intranet are being built has been increasing. Generally, this computer network is connected also to the Internet. Thereby, information can be exchanged between the inside of an organization, and the outside of an organization. Moreover, an affiliation member can perform active information interchange and information circulation for sharing information in an organization using an E-mail. Thus, the role of a computer network is important in the organization.

Generally, transmission and reception of the E-mail in this computer network are managed by the mail server prepared in this network. That is, when an E-mail is transmitted from a terminal, transmission of this E-mail is performed by the protocol (SMTP) prepared in the mail server. And it distributes through intranet or the Internet towards the addressee described at the E-mail. Thus, the distributed E-mail is kept in the mail box of a mail server by the protocol (POP) which receives an E-mail. And an addressee can read this E-mail, when logged in to the computer network to which he belongs by one's ID. In addition, when the addressee described at the E-mail is the affiliation member which the same mail server manages, this E-mail is kept by the mail box from SMTP. Such addressees are a specific individual, a specific group, etc.

There are the following problems in such an E-mail distribution system. An E-mail is transmitted only to the addressee which the transmitting person appointed. Therefore, the information indicated by the E-mail is not transmitted other than the addressee which the transmitting person appointed. That is, in many cases, the information exchanged among the persons in charge who take charge of a specific job does not get across to the job administrator who manages the job in an organization. Thus, when information exchange is performed among specific persons, there is a limit also in analyzing the information. For example, though information includes the w factor which brings an organization high profits, the information cannot fully be harnessed, and these high profits can be missed. Moreover, an affiliation member may exchange a private E-mail between the outside of an organization using the Internet. Therefore, it is also considered that a computer virus etc. advances from the outside of an organization. Then, the serious damage for the network system of an organization may be brought about by this computer virus.

The purpose of this invention is offering the E-mail distribution system which distributed the E-mail about a specific job to a person in charge and its job administrator automatically.

### SUMMARY OF THE INVENTION

This invention relates to the E-mail distribution system which distributes an E-mail. This E-mail distribution system is characterized by providing the automatic reading means which comes to have an individual data control area, an organization data control area, and an addressee addition program in the mail server. In the organization data control area, organization information, such as its post and job class, is memorized based on this personal information. It adds the e-mail address of this addressee to an E-mail while an addressee addition program will investigate a transmitting person's its affiliation post and job class from an individual data control area, will specify a transmitting person's job administrator from its above-mentioned affiliation post and job class which were memorized in the organization data control area and will appoint this transmitting person's job administrator to be a new addressee, if an E-mail is sent.

According to this composition, by the former, the transmission and reception of an E-mail currently performed only among persons in charge will be transmitted also to the job administrator to whom a transmitting person belongs. Thereby, a job administrator could carry out the job proper and efficiently, since he can grasp to the details of a job. Moreover, the job administrator could see this job information by the viewpoint different from a person in charge. Therefore, when the E-mail, for example, has the information which brings an organization profits, a possibility that the information can be found out and it can utilize improves. Moreover, the transmitting person of an E-mail will exercise self-control in transmission of the E-mail of the private purpose, since he has the E-mail looked at by one's job administrator. Thereby, the transmission and reception of the E-mail through the Internet which tended to become disorderly will become proper conventionally.

Consequently, invasion of a computer virus can be prevented. Thus, the excellent effect that the clarity of an organization improves is also born by exhibiting information in an organization.

And the desirable memory form of an individual data control area is indicated in code in which their post and job class of an affiliation member belonging to this organization consist of a sign showing it. The sign can be used as a code showing this job class. Or it can also consider as the sign connected with the personnel ID used in a common company. Thereby, the job class of an affiliation member can be distinguished easily.

And in the organization data control area, the organization information arranged by its post, job class, etc. based on the personal information memorized to the above-mentioned individual data control area is memorized. And a transmitting person's job administrator is specified to be an addressee using this organization information. The desirable memory form of this individual data control area and an organization data control area is that each data is arranged intelligibly so that a system manager can manage comparatively easily.

And when an E-mail is transmitted, an addressee addition program investigates a transmitting person's its post and job class from the personal information memorized in the individual data control area, and specifies a transmitting person's job administrator from the organization information memorized in the organization data control area based on a transmitting person's its post and job class. And when an E-mail is transmitted, an addressee addition program investigates a transmitting person's its post and job class from the personal information memorized in the individual data control area, and specifies a transmitting person's job administrator from the organization information memorized in the organization data control area based on a transmitting person's its post and job class. And when an E-mail is transmitted, an addressee addition program investigates a transmitting person's its post and job class from the personal information memorized in the individual data control area, and specifies a transmitting person's job administrator from the organization information memorized in the organization data control area based on a transmitting person's its post and job class. And this job administrator is appointed as an addressee.

And a job person's in charge e-mail address is added to an E-mail so that the E-mail concerned may be distributed to this job administrator. Here, in one preferred mode, the job administrator appointed to be an addressee is taken as the superior official on a job, or the group reader of a group which takes charge of the same job. Moreover, one person or two or more persons are satisfactory for the job administrator appointed as an addressee. Here, when appointing two or more persons' addressee, a transmitting person's under-the-direct-control superior, its superior, etc. can also be appointed to be job persons in charge. For example, in a company, when a common member transmits an E-mail, a section chief is appointed to be an addressee as a job administrator and when a section chief transmits an E-mail, the manager is appointed to be an addressee as a job administrator In one preferred mode of such an automatic reading means, when the addressee specified by the transmitting person and this transmitting person of an E-mail belongs to the same organization, each job administrator is newly appointed to be an addressee. And each job administrator can know the E-mail exchanged among the persons belonging to the same organization. Therefore, this job will be carried out proper and efficiently, since the job information indicated by this E-mail can be seen from a different viewpoint. Furthermore, a possibility that the information which may yield new profits will be found out also improves.

As one suitable mode of such an E-mail distribution system, before an E-mail is distributed by SMTP (mail transfer protocol which distributes an E-mail), an above-mentioned automatic reading means is made to perform. Thereby, since it is not necessary to change SMTP, the mail server used now can be used.

In one preferred mode of an E-mail distribution system, when the addressee specified by the transmitting person and this transmitting person of an E-mail belongs to the same organization, CC (carbon copy) of this E-mail is distributed to the addressee newly appointed by the above-mentioned automatic reading means. Thereby, the addressee which received the E-mail can judge easily whether this E-mail is the original or the copy. Consequently, since those who should cope with the information on this E-mail are clarified, this information can be processed quickly.

In one preferred mode of an E-mail distribution system, when the organizations to which the transmitting person of an E-mail and the addressee which this transmitting person appointed belong, respectively differ, BCC (blind carbon copy) of this E-mail is distributed to the addressee newly appointed by the above-mentioned automatic reading means. In this way, as the addressee outside an organization does not understand the addressee newly appointed by this automatic reading means, it is considered to the addressee outside an organization.

### BRIEF DESCRIPTION OF THE DRAWINGS

Other objects, features and advantages of the present invention will become apparent from the detailed description of the preferred embodiments which follows, when considered in light of the accompanying drawings, in which:

FIG. 1 is a figure showing the E-mail distribution system in the typical computer network by this invention;

FIG. 2 is a flowchart figure showing such an E-mail distribution system;

FIG. 3 is a screen mode showing an example of an individual data register screen which manages an individual data control area;

FIG. 4 is a screen mode showing an example of its post data register screen which manages its post data control area;

FIG. 5 is a screen mode showing an example of an organization data register screen which manages an organization data control area;

FIG. 6 is the sample of an organization system figure of the company concerning this invention.

### DETAILED DESCRIPTION OF THE PREFERRED EMBODIMENTS OF THE INVENTION

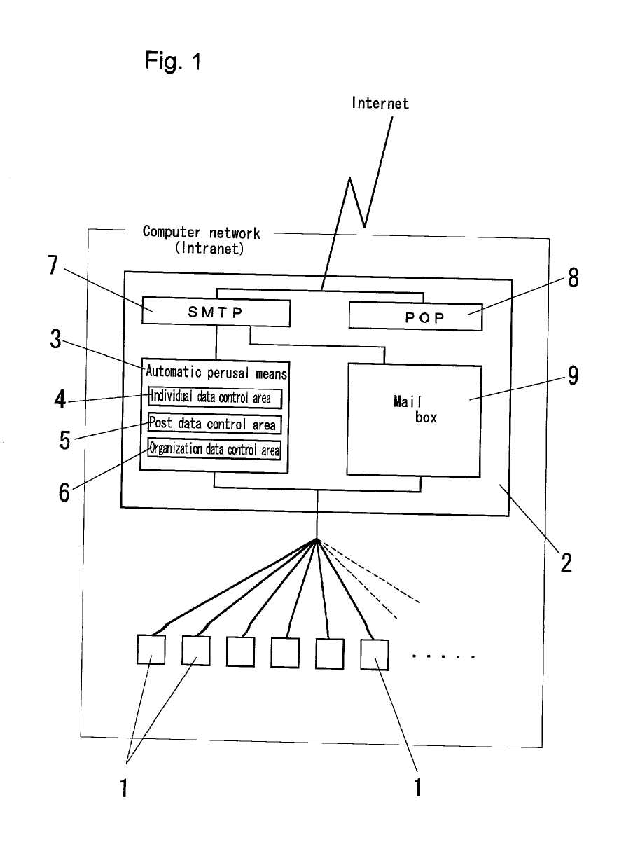

FIG. 1 shows the E-mail distribution system in the computer network (LAN) built in the company. Two or more terminals 1 are connected to a mail server 2. Since this mail server 2 is connected to the Internet, information interchange with company outside is possible. User ID is published to the member registered into this network. And when this member logs in from a terminal 1 by this user ID, transmission and reception of an E-mail are possible.

The automatic reading means 3 is formed in this mail server 2, and the E-mail sent from the terminal 1 is transmitted by the automatic reading means 3. The individual data control area 4 which memorizes a registrant's personal information, their post data control area 5 which memorizes its post information of this company, and the organization data control area 6 are established in the storage of this automatic reading means 3. In this organization data control area 6, arrangement memory of the organization information constituted based on personal information and its post information is carried out. Furthermore, the addressee addition program for adding a new addressee to an E-mail is stored in this storage. This addressee addition program is started at the same time an E-mail is sent to a mail server 2, and it performs predetermined processing using the information memorized, respectively to the individual data control area 4, its post data control area 5, and the organization data control area 6.

Moreover, SMTP7 which is the protocol which transmits an E-mail, and POP8 which is the protocol which receives an E-mail are formed in this mail server 2. Thereby, transmission and reception of an E-mail with the w outside of a company are performed through the Internet. This SMTP7 distributes the E-mail sent through this automatic reading means 3 to each addressee. Furthermore, the mail box 9 which keeps an E-mail is connected to SMTP7 and POP8. This mail box 9 is an area which carries out memory storage of the E-mail addressed to the registrant of this computer network (LAN).

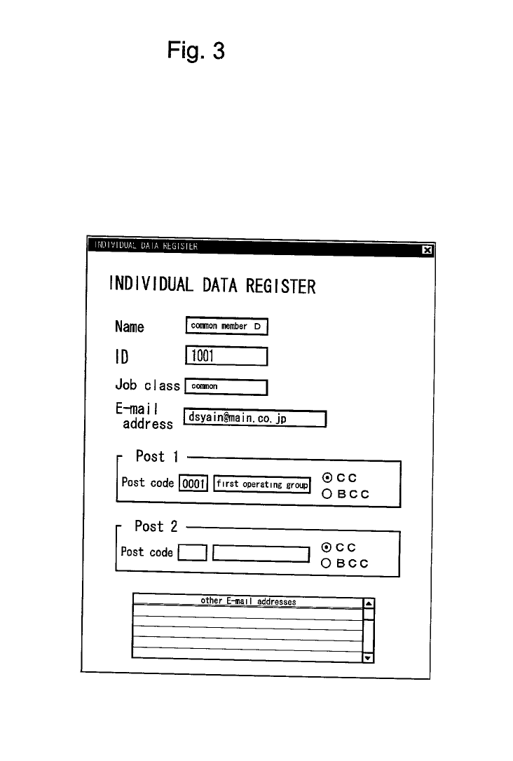

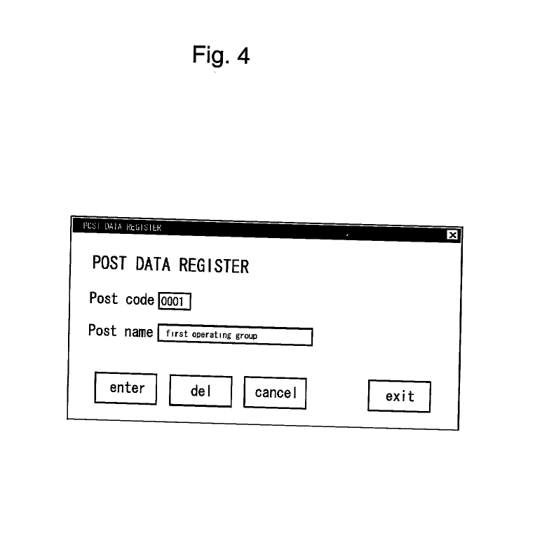

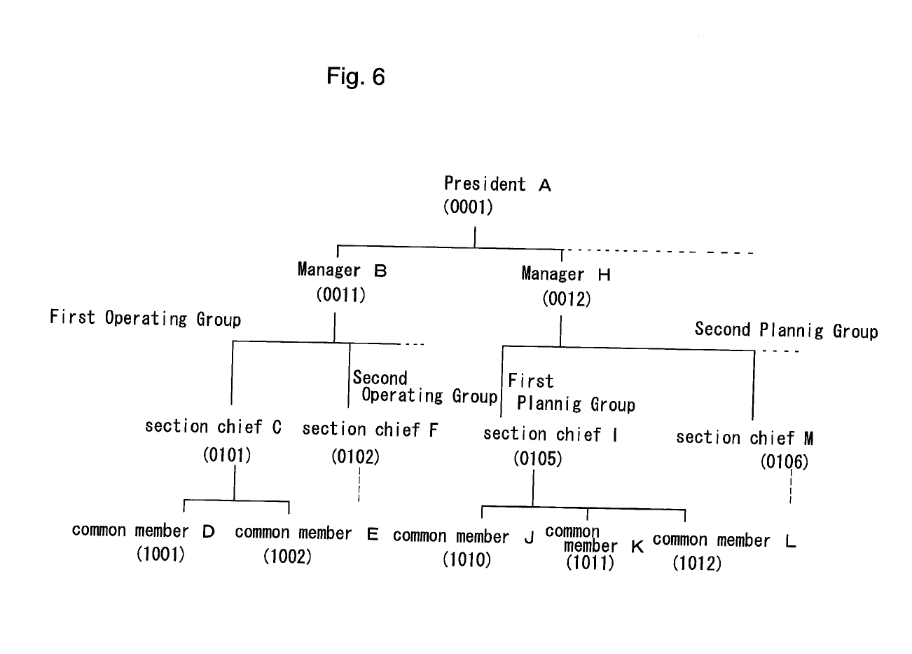

Next, the principal part of this invention is explained. Their name, Member ID and job class, e-mail address, and their affiliation post of the member registered into the individual data control area 4 established in the storage of a mail server 2 by this computer network (LAN) as shown in FIG. 3 are memorized. This e-mail address is used as user ID. Moreover, Member ID considers as the job code showing job class, and he makes the number of Members ID small as job class becomes high (refer to FIG. 6). For example, as for Member ID, the president “0001” The manager “0011” A section chief “0101” A common member “1001” It sets up. And their post code and their post name are memorized by their affiliation post. These are memorized to their post data control area 5 shown in FIG. 4, and are making their post name and their post code of its of this company correspond.

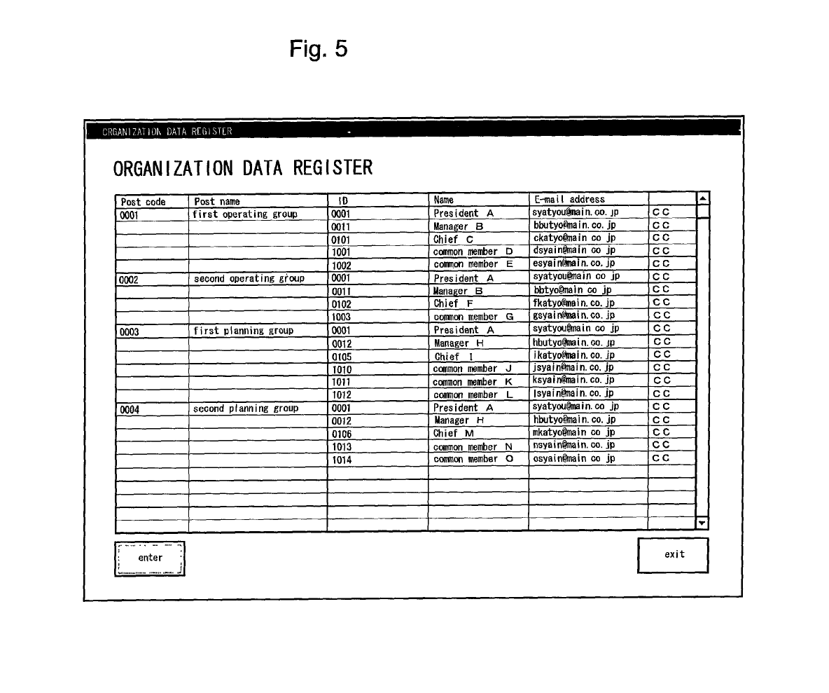

Moreover, in the organization data control area 6, as shown in FIG. 5, their post code of the member of this company, a member code, a member name, an e-mail address, etc. are arranged in order of every affiliation post of their and a job hierarchy, and are memorized. These data are constituted by each data memorized to the individual data control area 4 and its post data control area 5. Thus, since the organization data control area 6 is arranged in the high sequence (small sequence of a member code) of job class for every post of its, the superior of the member who transmitted the E-mail may be specified easily.

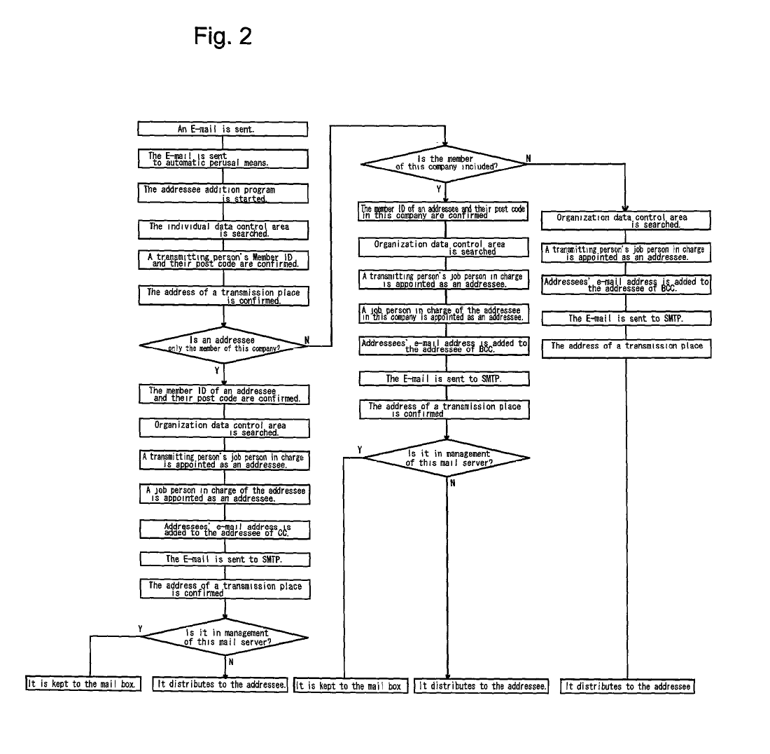

Next, an E-mail distribution system is explained according to FIG. 2. In addition, this company has the organization system shown in FIG. 6. The number in the parenthesis of this FIG. 6 is Member ID.

As the first case, the common member D who belongs to the First Operating Group of a company transmits an E-mail from the terminal 1 connected to a computer network by making into an addressee the common member K who belongs to the First Planning Group. If this E-mail is sent to a mail server 2, the addressee addition program of the automatic reading means 3 will start. This addressee addition program confirms Member ID and its affiliation post code of the common member E who is a transmitting person from the individual data control area 4. It judges with it being the common member K of this company simultaneously from the e-mail address of the addressee which the transmitting person appointed, and the common member's K Member ID and their affiliation post code are confirmed from the individual data control area 4.

And the job environment in its affiliation post of the common member D and the common member E its memorized to the organization data control area 6 is confirmed in this member ID and its affiliation post code. And while specifying the section chief C of the First Operating Group as the common member's D job administrator, the section chief I of the First Planning Group is specified as the common member's K job administrator. And the section chief C of the First Operating Group and the section chief I of the First Planning Group are newly appointed as an addressee. In this case, this newly appointed addressee is taken as every one superior each of the addressee which the transmitting person and this transmitting person appointed. The addressee specified by this addressee addition program can be set up variously. For example, two superiors, the section chief C of the First Operating Group and Manager B, can be specified, and the common member's D job administrator can also be set up so that this two person may newly be appointed as an addressee.

And an addressee addition program confirms the email address of the newly appointed addressee from the organization data control area 6, and adds it to the addressee of CC (carbon copy) of the E-mail concerned. Moreover, when added to a new addressee, it can choose in the individual data control area 4 so that an E-mail may be distributed by either CC or BCC. For example, when set as BCC, the e-mail address of an addressee is added to the addressee of BCC.

Then, this E-mail is distributed to each addressee by SMTP7 according to the mail address of each addressee, respectively. Thus, when all addressees are managed by the same mail server 2, an E-mail is sent to a mail box 9 by SMTP7, and is kept. And when the common member K, the section chief C of the First Operating Group, and the section chief I of the First Planning Group log in to a computer network, respectively, this E-mail can be read.

As the second case, the above-mentioned common member D sends an E-mail to the member of another company. If this E-mail is sent to a mail server 2, the addressee addition program of the automatic reading means 3 will start. This addressee addition program confirms Member ID and its affiliation post code of the common member E who is a transmitting person from the individual data control area 4. And in this member ID and one's affiliation post code, the section chief C of the First Operating Group which is the common member's D job administrator is specified from the organization data control area 6, and the section chief C of the First Operating Group is newly appointed as an addressee. And the e-mail address of the section chief C of this First Operating Group is added to the addressee of BCC of this E-mail. Then, this E-mail is transmitted to the member of another company which the common member D appointed through the Internet by SMTP7. Simultaneously, BCC of this E-mail is kept with the mail box in this mail server 2.

Such an E-mail distribution system is managed by the system manager in a company. A system manager can confirm and set up the individual data control area 4, the post data control area 5, and the organization data control area 6 on the screen of a terminal 1. The individual data control area 4 is expressed as the individual data registration screen shown in FIG. 3 for every each people. The post data control area 5 is expressed as its post data registration screen shown in FIG. 4.

The organization data control area 6 is expressed as the organization data registration screen shown in FIG. 5. Thus, since personal information, their post information, and organization information can be checked, it is easy for a system manager to make the input and change of a required matter to these information on a registration screen.

According to the above-mentioned E-mail distribution system, since the information in the job which a transmitting person takes charge of is transmitted also to a job administrator, the excellent effect that the job is efficiently more proper and executable is produced. Since the information in the job which a transmitting person takes charge of will be transmitted also to a job administrator by such E-mail distribution system, the excellent effect that the job may be carried out proper and efficiently arises. Moreover, since the E-mail of the private purpose unrelated to a job can also be deterred, the transmission and reception of the E-mail through the Internet which tended to become disorderly will be limited proper conventionally. Thereby, the effect which prevents invasion of a computer virus improves.

Moreover, when the transmitting person and transmission place of an E-mail belong to the same organization, this E-mail is distributed by making each job administrator into a visitor. Moreover, when the transmitting person of an E-mail and the addressee specified by this transmitting person belong to the same company, each job administrator is newly appointed as an addressee, and this E-mail is distributed. Thereby, since each job administrator can recognize this E-mail, the job may be carried out more proper and efficiently. Furthermore, a possibility that the information which brings a company new profits can be found out also improves.

The invention may be embodies in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. In the E-mail distribution system which distributes the E-mail sent from the terminal linked to a computer network by the E-mail transmission protocol prepared in the mail server which manages transmission and reception of an E-mail to the appointed addressee
the E-mail distribution system characterized by providing the automatic reading means in the mail server include;
the individual data control area which memorizes personal information, such as its affiliation post and job hierarchy of the affiliation member of an organization, and an e-mail address;
the organization data control area which memorizes organization information, such as its affiliation post and a job class, based on this personal information;
and the addressee addition program which adds the email address of this addressee to an E-mail while investigating a transmitting person's one's affiliation post and job class from an individual data control area, specifying a transmitting person's job administrator from one's above-mentioned affiliation post and job class which were memorized in the organization data control area and appointing this transmitting person's job administrator to be a new addressee, if an E-mail is sent.

2. When the transmitting person of an E-mail and the addressee which this transmitting person appointed belong to the same organization If an E-mail is sent,
an E-mail distribution system given in the claim 1 equipped with the addressee addition program which adds the e-mail address of this addressee to an E-mail while investigating one's affiliation post and job class of a transmitting person and an addressee from an individual data control area, respectively, specifying a transmitting person and each job administrator of an addressee from one's above-mentioned affiliation post and job class which were memorized in the organization data control area and appointing this transmitting person and each job administrator of an addressee to be new addressees.

3. An E-mail distribution system given in the claim 1 or 2 characterized by performing an automatic reading means, before an E-mail is sent to an E-mail transmission protocol.

4. An E-mail distribution system given in the claim 1,2 or 3 characterized by distributing CC (carbon copy) of this E-mail to the addressee newly appointed by the automatic reading means, when the transmitting person and the addressee specified by this transmitting person belong to the same organization.

5. An E-mail distribution system given in the claim 1,2,3 or 4 characterized by distributing BCC (blind carbon copy) of this E-mail to the addressee newly appointed by the automatic reading means, when the organizations to which a transmitting person and the addressee which this transmitting person appointed belong, respectively differ.
